(19) United States
(12) Patent Application Publication
(10) Pub. No.: US 2007/0214652 A1
(43) Pub. Date: Sep. 20, 2007

(54) Folding utility knife

(76) Inventor: Qiu Jian Ping, Hangzhou (CN)

Correspondence Address: WILLIAM COLLARD;COLLARD & ROE, P.C., 1077 NORTHERN BOULEVARD, ROSLYN, NY, 11576, US

(21) Appl. No.: 11/800,684

(22) Filed: May 7, 2007

Related U.S. Application Data
(63) Continuation of application No. 10/909,449, filed on Aug. 2, 2004.

(30) Foreign Application Priority Data
Mar. 19, 2004 (CN) 2004-20008854.6

(51) Int. Cl. B26B 3/06

(52) U.S. Cl. 30/161

(57) ABSTRACT

A utility knife having a handle and a blade holder which is pivotally mounted on the handle for movement from an unfolded position to a folded position. The handle has a space adapted to receive the blade holder when the blade holder is in its folded position. The blade holder includes a main wall and guard wall mounted together and adapted to receive a blade therebetween and a locking pivotally mounted on the blade holder to lock the blade in place.

### BACKGROUND

This application is an improvement over U.S. patent application Ser. Nos. 10/437,089 filed May 13, 2003 and 10/570,134 filed Dec. 31, 2003, the contents of which are incorporated herein by reference.

The present invention relates to a utility knife and more particularly to a folding utility knife in which the blade may be folded into the handle when the knife is not in use.

Utility knives have been used for a number of years. Some of the utility knives in use have blades that are mounted on a blade holder which is foldable within a handle when the knife is not in use. However, some of these utility knives have many movable parts which makes them difficult to use and expensive to manufacture. In addition, in some of these utility knives replacement of the blade is a complicated operation any may require special tools.

### OBJECTS

The present invention overcomes these problems and has for one its objects the provision of an improved utility knife in which the blade holder may be easily folded into a handle.

Another object of the present invention is the provision of an improved utility knife in which the blade is held securely on the utility knife.

Another object of the present invention is the provision of an improved utility knife in which improved means are provided for replacing the blade on the utility knife.

Another object of the present invention is the provision of an improved utility knife which is simple to use and inexpensive to manufacture and maintain.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

FIG. 1 is a perspective view of a utility knife made in accordance with the present invention.

FIG. 2 is a top plan view thereof.

FIG. 3 is a sectional view taken along the line 3-3 of FIG. 2.

FIG. 4 is a sectional view similar to FIG. 3 showing the utility knife in a partially folded position.

FIG. 5 is a sectional view similar to FIG. 3 showing the utility knife in a fully folded position.

FIG. 6 is a sectional view taken along lines 6-6 of FIG. 2.

FIG. 7 is a sectional view taken along line 7-7 of FIG. 2.

FIG. 8 is a sectional view similar to FIG. 6 showing the blade being removed.

FIG. 8A shows a variation of FIG. 8.

FIG. 9 is a sectional view taken along line 9-9 of FIG. 8.

FIG. 10 is a plan view of another side of the folding utility knife of the present invention.

FIG. 11 is a perspective view of another embodiment of the present invention.

FIG. 12 is a top plan view thereof.

FIG. 13 is a sectional view taken along the line 13-13 of FIG. 12.

FIG. 14 is a sectional view similar to FIG. 13 showing the utility knife in a partially folded position.

FIG. 15 is a sectional view similar to FIG. 13 showing the utility knife in a fully folded position.

FIG. 16 is a sectional view taken along lines 16-16 of FIG. 12.

FIG. 17 is a sectional view taken along line 17-17 of FIG. 12.

FIG. 18 is a sectional view similar to FIG. 17 showing the blade being removed.

FIG. 19 is a sectional view taken along line 19-19 of FIG. 18.

FIG. 20 is a plan view of another side of the folding utility knife of the present invention.

### DESCRIPTION

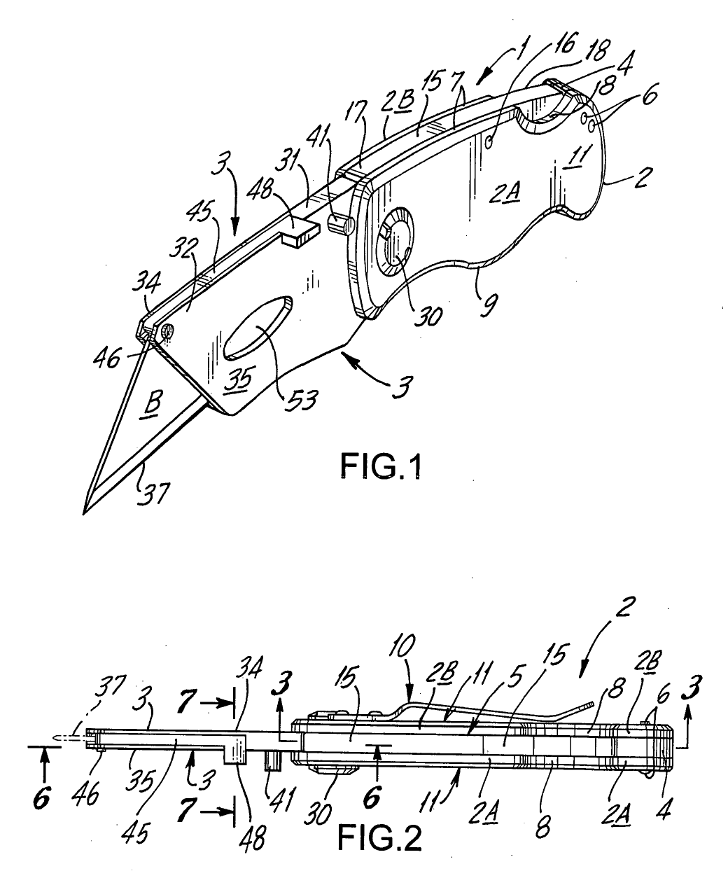

Referring to the drawings, and more particularly to the embodiment of the invention shown in FIGS. 1 to 10, the utility knife 1 of the present invention comprises a handle 2 and a blade holder 3.

The handle 2 comprises a pair of handle halves 2A and 2B each having an outer side wall 11, an upper edge 7 and a lower edge 9. A rear spacer 4 is provided between the handle halves 2A and 2B to maintain the handle halves 2A and 2B separated and to create a space 5 between handle halves 2A and 2B. The spacer 4 and the handle halves 2A and 2B may be held together by fasteners 6 which pass through the spacer 4 and the handle halves 2A and 2B in order to hold them together. The upper edge 7 of the handle halves 2A and 2B (i.e. the entire handle 2) has a finger notch 8 and the lower edge 9 of the handle halves 2A and 2B (i.e. the entire handle 2) may be undulated in order to permit the user's fingers to grip the handle 2. If desired, a clip 10 may be mounted on a side wall 11 of the handle halves 2A and/or 2B to permit the utility knife 1 to be fastened onto the user's belt or some other convenient place.

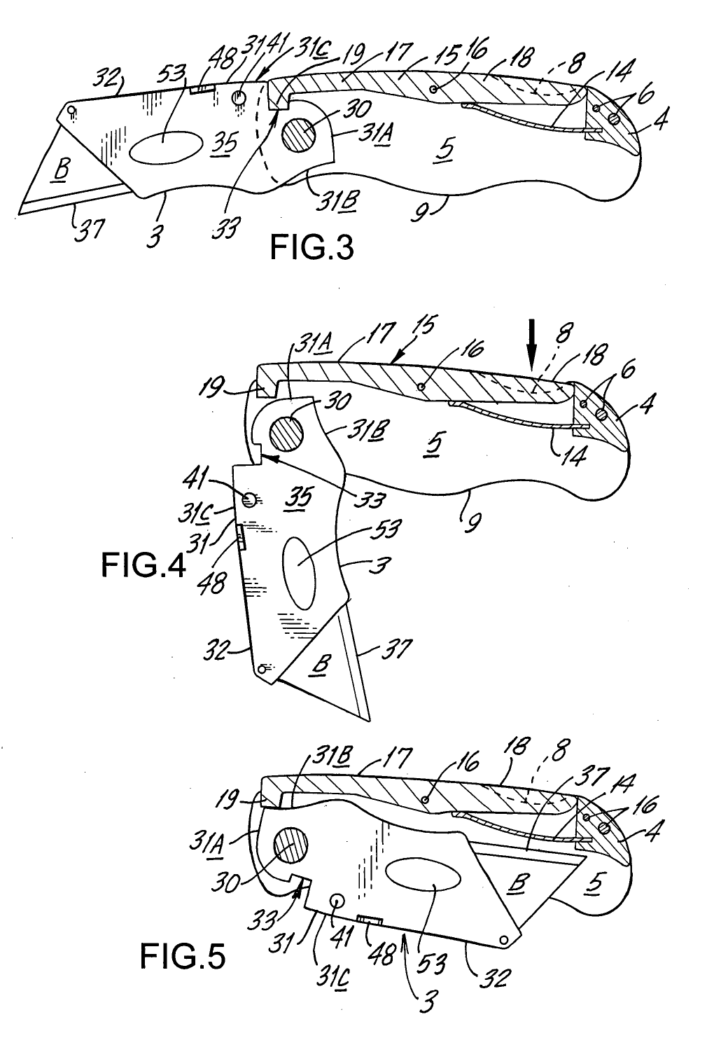

Interposed between the handle halves at 2A and 2B and along the upper edges 7 of the handle halves 2A and 2B there is provided a lock lever assembly 15 (FIGS. 3 to 5) which is pivotally mounted between the handle halves 2A and 2B on a pivot pin 16 which extends through the two handle halves 2A and 2B and the lock lever assembly 15. The lock lever assembly 15 is preferably a two arm lever having front and rear arms 17 and 18, respectively. The front arm 17 is provided with a downwardly extending lock finger 19. Below the rear arm 18 of the lock lever assembly 15 there is provided a spring 14 which normally bears against the bottom edge of the rear arm 18 to force the rear arm 18 upwardly and the front arm 17 downwardly around the pivot 16 so that rear arm 18 protrudes above the notch 8. It will be seen that when the rear arm 18 of the lock lever assembly 15 is pressed down manually through the notch 8 against the action of spring 14, the front arm 17 will be raised.

The blade holder 3 of the present invention comprises a rear end 31 and a front end 32 which are preferably one piece and integral with each other.

The rear end 31 of the blade holder 3 has rear edge 31A bottom edge 31B and upper edge 31C. The blade holder 3 is pivotally mounted in the space 5 between handle halves 2A and 2B on a pivot pin 30. A finger knob 41 may be provided on the rear end 31 to facilitate the pivotal movement of the blade holder 3 relative to the handle 2. The upper edge 31C of the rear end 31 has a lock groove 33 into which the downwardly extending lock finger 19 of the lock assembly 15 is adapted to enter when the blade holder 3 is in its extended or unfolded position.

The blade holder 3 comprises a thin main wall 34 and a thin guard wall 35 which are held together by any well known means such as by welding them together or by fastening them together with suitable fasteners. If desired they may be made of one piece and integral with each other. The opposed inner portions of walls 34 and 35 adjacent the upper edge 36 are thinner than the thickness of the other portions of the walls 34 and 35 to form a groove 50 therebetween. The groove 50 has a downwardly extending clearance area 51 communicating therewith. The walls 34 and 35 have an elongated slit 52 formed therein which is adapted to receive and hold a blade B therein between walls 34 and 35. The blade B preferably has a lower cutting edge 37 and spaced notches 38 in its upper edge 39. The blade B is adapted to slide in and out of the slit 52 between the walls 34 and 35. Openings 53 may be provided in the walls 34 and 35 to permit the user to assist in coaxing the blade B in and out of slit 52.

A blade lock arm 45 is pivotally mounted within the groove 50 on a pivot pin 46 for pivotal movement in and out of the groove 50. Preferably, the pivot pin 46 is located at the front end 32 of the blade holder 31 and the blade lock arm 45 is pivoted on its front end 45F. However, the pivot pin 46 may be located at the rear end 31, if desired, in which event the blade lock arm 45 would be pivoted on its rear end 45R. The blade lock arm 45 has a downwardly extending blade finger 47 and a finger tab 48 extending laterally therefrom. When the blade lock arm 45 is pivoted downwardly around pivot 46, it will sit in the groove 50 and its blade finger 47 will enter into one of the upper notches 38 on blade B in order to lock the blade B in place. The downwardly extending clearance area 51 in the groove 50 will receive and accommodate the outer edges of the blade finger 47 when it is in its downward position. When it is desired to remove and replace the blade B, the blade lock arm 45 is pivoted upwardly by means of its finger tab 48 to move it out of the groove 50 and to move the blade finger 47 out of the blade notch 38 to release the blade B and permit it to be slid out of the slit 52. It will be understood that rather than a single blade finger 47, as shown, it is within the purview of the present invention to have a plurality of blade fingers 47 to enter the notches 38 in the blade.

FIG. 8A discloses a variation in which a compression spring means 49 will hold the blade lock arm 45 down within the groove 50 with its blade finger 47 entered in the upper blade notch 38. When it is desired to remove the blade B, the blade lock area 45 is raised out of the groove 50 against the tension of the spring 49 to release the blade B.

In operation of the utility knife shown in the embodiment of FIGS. 1 to 10, the utility knife 1 is placed in its operative unfolded position with the blade holder 3 unfolded and ready to be used. The blade B is held in the slit 52 by the blade finger 47 of the blade lock arm 45 (which is in its lower position) extending into a notch 38 in the top edge 39 of the blade B. The lock finger 19 of the front arm 17 of the lock lever assembly 15 is in its lower position (because of the pressure of spring 14 on rear arm 18) and is positioned in the groove 33 in the blade holder 3 in order to hold the blade holder 3 in its unfolded position. The rear arm 18 of the lock lever assembly 15 is in its raised position and protrudes above the finger notch 8 at the top edge 7 of the handle 2.

When it is desired to place the utility knife 1 into its folded inoperative position, the rear arm 18 of the lock lever assembly 15 is pressed down manually through the notch 8 against the bias of the spring 14. This causes the front arm 17 of the lock lever assembly 15 to be raised thereby moving the lock finger 19 out of the groove 33 to release the blade holder 3 and permit it to pivot downwardly around the pivot pin 30 (FIG. 4). This may be accomplished by pushing down on the finger knob 41. The blade holder 3 is then pivoted down completely into the space 5 between the handle halves 2A and 2B (FIG. 5). When pressure on rear arm 18 is released, the spring 14 moves the rear arm 18 back to its original raised position by the tension of the spring 14. This causes the lock finger 19 to bear against the button edge 31B of the blade holder 3 thereby holding the blade holder 3 in its folded position.

When it is desired to use the blade B, the reverse procedure is followed. The blade holder 3 is pivoted in the opposite direction. It may be desirable for the rear arm 18 of the lock lever assembly 5 to again be depressed manually to assist in unfolding the blade holder 3. The blade holder 3 is continued to be rotated counter-clockwise (as seen in FIG. 4) until the lock finger 19 of the front arm 17 enters into the groove 33 in the rear end 31 of the blade holder 3 in order to hold the blade holder 3 in its extended position.

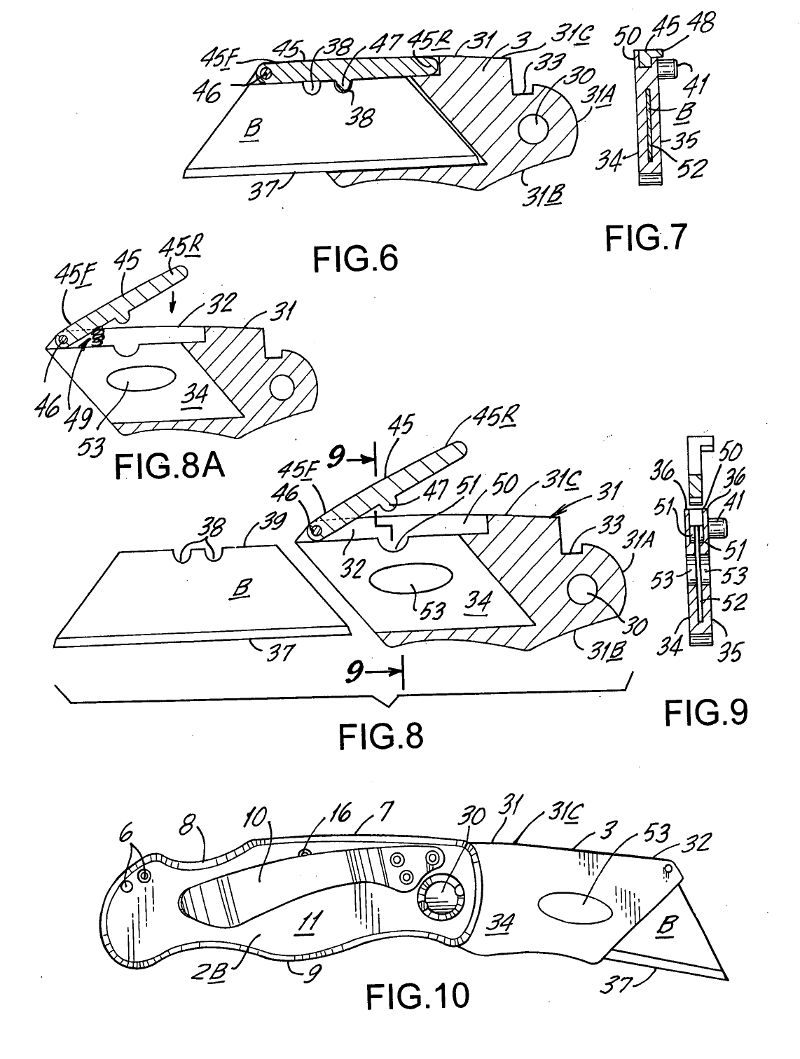

When it is desired to replace a blade B, the blade holder 3 is placed in its unfolded position (as shown in FIG. 6) and the blade lock arm 45 is lifted upwardly around pivot 46 out of the groove by means of finger tab 48 thereby moving the blade finger 47 out of the notch 38 in the upper blade edge 39 of the blade B to release the blade B. In the FIG. 8A variation this is done against the tension of the spring 49. The blade B can then be moved out of the blade holder 3 through slit 52 and a new blade B can be placed therein through the slit 52. The blade lock arm 45 is then lowered back into the groove 50 (in the FIG. 8A variation by spring 49) to move the blade finger 47 into the notch 38 in the blade B to lock the blade B in place.

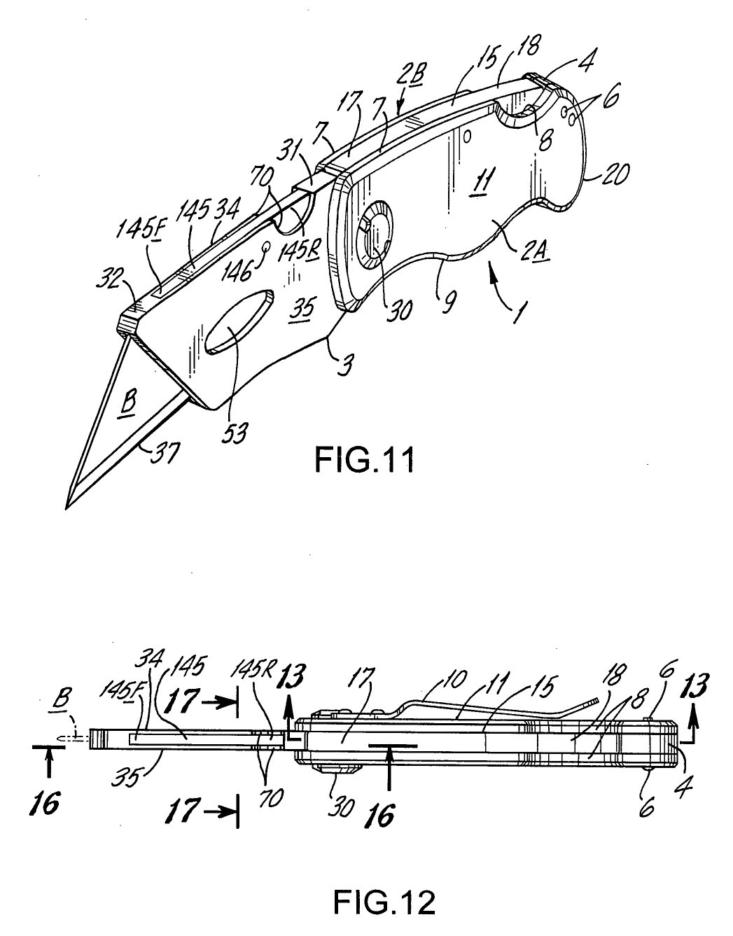

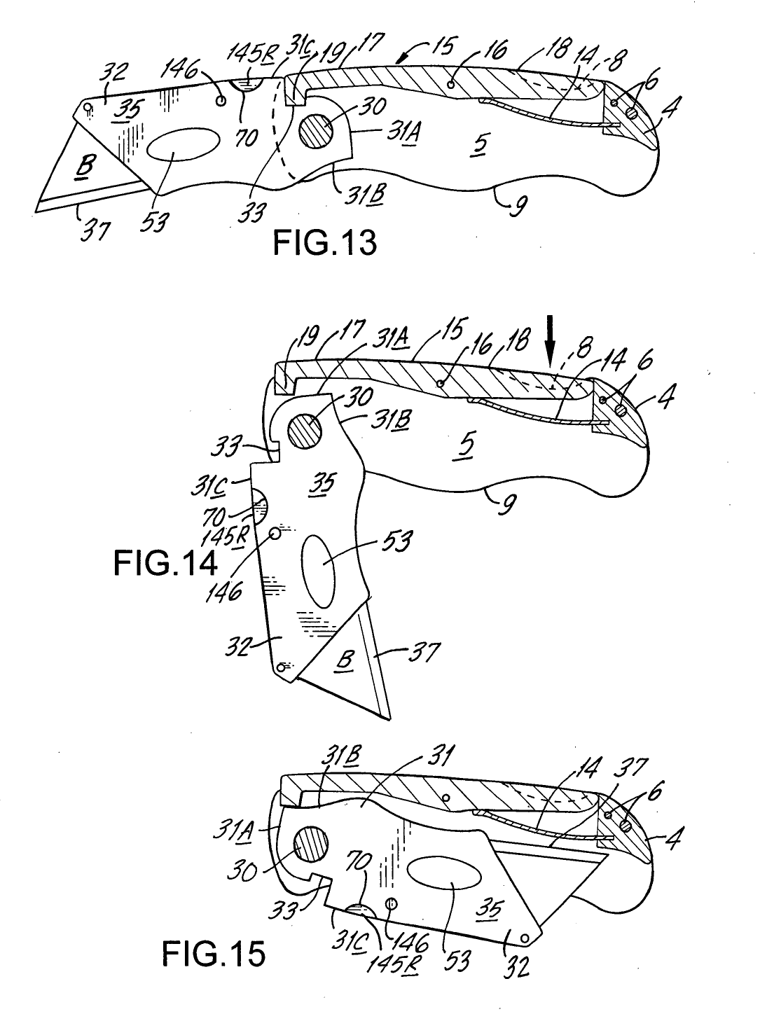

Referring now to the embodiment of the invention shown in FIGS. 11 to 20, structures in this embodiment which are the same as structures in the FIGS. 1 to 10 embodiment will be identified by the reference numerals.

The utility knife 1 shown in the FIGS. 11 to 20 embodiment comprises a handle 2 and a blade holder 3. The handle 2 comprises a pair of handle halves 2A and 2B each having an outer side wall 11, an upper edge 7 and a lower edge 9. A rear spacer 4 is provided between the handle halves 2A and 2B to maintain the handle halves 2A and 2B separated and to create a space 5 between handle halves 2A and 2B. The spacer 4 and the handle halves 2A and 2B may be held together by fasteners 6 which pass through the spacer 4 and the handle halves 2A and 2B in order to hold them together. The upper edge 7 of the handle halves 2A and 2B (i.e. the entire handle 2) has a finger notch 8 and the lower edge 9 of the handle halves 2A and 2B (i.e. the entire handle 2) may be undulated in order to permit the user's fingers to grip the handle 2. If desired, a clip 10 may be mounted on a side wall 11 of the handle halves 2A and/or 2B to permit the utility knife I to be fastened onto the user's belt or some other convenient place.

Interposed between the handle halves at 2A and 2B and along the upper edges 7 of the handle halves 2A and 2B there is provided a lock lever assembly 15 (FIGS. 3 to 5) which is pivotally mounted between the handle halves 2A and 2B on a pivot pin 16 which extends through the two handle halves 2A and 2B and the lock lever assembly 15. The lock lever assembly 15 is preferably a two arm lever having front and rear arms 17 and 18, respectively. The front arm 17 is provided with a downwardly extending lock finger 19. Below the rear arm 18 of the lock lever assembly 15 there is provided a spring 14 which normally bears against the bottom edge of the rear arm 18 to force the rear arm 18 upwardly and the front arm 17 downwardly around pivot 16 so that rear arm 18 protrudes above the notch 8. I will be seen that when the. rear arm 18 of the lock lever assembly 15 is pressed downwardly through the notch 8 action of spring 14, the front arm 17 will be raised.

The blade holder 3 of the present invention comprises a rear end 31 and a front end 32 which are preferably one piece and integral with each other.

The rear end 31 of the blade holder 3 has rear edge 31A bottom edge 31B and upper edge 31C. The blade holder 3 is pivotally mounted in the space 5 between handle halves 2A and 2B on a pivot pin 30. The upper edge 31C of the rear end 31 has a lock groove 33 into which the downwardly extending lock finger 19 of the lock assembly 15 is adapted to enter when the blade holder 3 is in its extended or unfolded position.

The blade holder 3 comprises a thin main wall 34 and a thin guard wall 35 which are held together by any well known means such as by welding them together or by fastening them together with suitable fastening means. If desired they may be made of one piece and integral with each other. The opposed inner portions of walls 34 and 35 adjacent the upper edge 36 are internally thinner than the thickness of the other portions of the walls 34 and 35 to form a groove 50 therebetween. The groove 50 has a downwardly extending clearance area 51. The walls 34-35 have a finger notch 70 adjacent rear end 31 of the blade holder 3. The walls 34 and 35 have an elongated slit 52 formed therein which is adapted to receive and hold a blade B therein between the walls 34 and 35. The blade B preferably has a lower cutting edge 37 and spaced notches 38 in its upper edge 39. The blade B is adapted to slide in and out of the slit 52 between the walls 34-35. Openings 53 may be provided in the walls 34-35 to permit the user to assist in coaxing the blade B in and out of slit 52.

A blade lock arm 145 is pivotally mounted within the groove 50 on a pivot pin 146. Preferably the pivot pin 146 is located at the rear end 31 of the blade holder 31, but may be located at the front end 32, if desired. The blade lock arm 145 is preferably a two arm lever having front and rear arm 145F and 145R, respectively. The front arm 145F is provided with a pair of downwardly extending blade fingers 147, although a single blade lock finger 17 (or more than two if blade B has more than two upper edge notches 38) may be used, if desired. Below the rear arm 145R of the blade lock arm 145 there is provided a spring 160 which normally bears against the bottom of the rear arm 145R to force the rear arm 145R upwardly and the front arm 145F downwardly around the pivot 146 so that rear arm 145R protrudes above the finger notch 70. It will thus be seen that when the rear arm 145R of the lock blade arm 145 is pressed down manually through the finger notch 70 against the action of spring 160, the front arm 145F will be raised. When the arm 145 is pivoted downwardly around pivot 146 under tension from the spring 160 it sits in the groove 50 and its blade fingers 147 on the front arm 145F will enter into the upper notches 38 on blade B in order to lock the blade B in place. The downwardly extending clearance areas 51 in the groove 50 will receive and accommodate the outer edges of the blade fingers 147 when they are in their downward position. When it is desired to remove and replace the blade B, the rear arm 145R is pivoted upwardly by applying manual pressure to the rear arm 145R through finger notch 70 to cause the front arm 145F, of the blade lock arm 145 to move out of the groove 50 and to move the blade fingers 147 out of the notches 38 to release the blade B and permit it to be slid out of the slit 52.

In operation of the utility knife, shown in the embodiment of FIGS. 1 to 10, the utility knife 1 is placed in its operative unfolded position with the blade holder 3 unfolded and ready to be used. The blade B is held in the slit 52 by the blade finger 47 of the blade lock arm 45 (which is in its lower position) extending into a notch 38 in the top edge 39 of the blade B. The lock finger 19 of the front arm 17 of the lock lever assembly 15 is in its lower position (because of the pressure of spring 14 on rear arm 18) and is positioned in the groove 33 in the blade holder 3 in order to hold the blade holder 3 in its unfolded position. The rear arm 18 of the lock lever assembly 15 is in its raised position and protrudes above the finger notch 8 at the top edge 7 of the handle 2.

When it is desired to place the utility knife 1 into its folded inoperative position, the rear arm 18 of the lock lever assembly 15 is pressed down manually through the finger notch 8 against the bias of the spring 14. This causes the front arm 17 of the lock lever assembly 15 to be raised thereby moving the lock finger 19 out of the groove 33 to release the blade holder 3 and permit it to pivot downwardly around the pivot pin 30 (FIG. 14). The blade holder 3 is then pivoted down completely into the space 5 between the handle halves 2A and 2B (FIG. 15). When pressure on rear arm 18 is released, the spring 14 moves the rear arm 18 back to its original raised position by the tension of the spring 14. This causes the lock finger 19 to bear against the bottom edge 31 B of the blade holder 3 thereby holding the blade holder 3 in its folded position.

When it is desired to use the blade B, the reverse procedure is followed. The blade holder 3 is pivoted in the opposite direction. It may be desirable for the rear arm 18 of the lock lever assembly 5 to again be depressed manually to assist in unfolding the blade holder 3. The blade holder 3 is continued to be rotated counter-clockwise (as seen in FIG. 14) until the lock finger 19 of the front arm 17 enters into the groove 33 in the rear end 31 of the blade holder 3 in order to hold the blade holder 3 in its extended position.

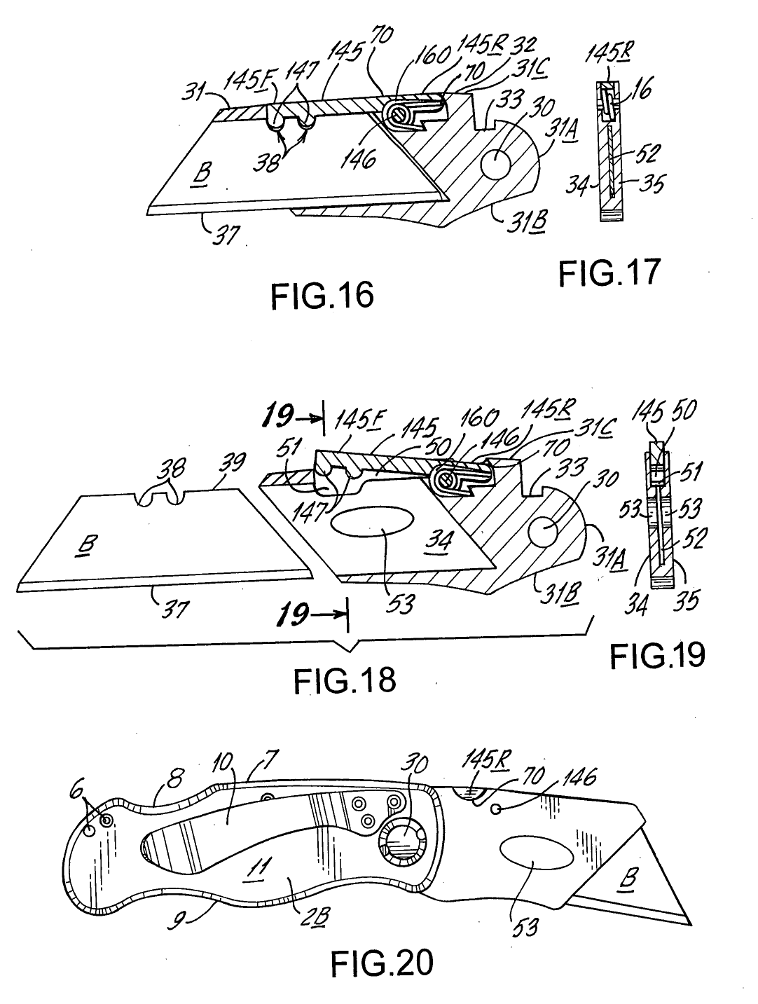

When it is desired to replace a blade B, the blade holder 3 is placed in its unfolded position (as shown in FIG. 16) and the blade lock arm 145 has its front arm 145F lifted upwardly around pivot 146 by applying pressure to the rear arm 145R through finger notch 70 thereby moving the blade lock arm 145 out of the groove 50 and moving the blade fingers 147 out of the notches 38 in the upper blade edge 39 to release the blade B. The blade B can then be moved out of the blade holder 3 through slit 52 and a new blade B can be placed therein through the slit 52. The blade lock arm 145 is then lowered by releasing downward pressure on the rear arm 145R through finger notch 70 to lower the blade lock arm 145 back into its groove 50 under tension of spring 160 and to move the blade fingers 147 into the notches 38 in the blade B to lock the blade B in place.

It will be seen that the present invention provides a utility knife in which the blade holder may be easily folded into a handle in which improved means are provided for securing the blade on the utility knife and for replacing the blade on the knife and which is simple to use and inexpensive to manufacture and maintain.

As many and varied modifications of the subject matter of this invention will become apparent to those skilled in the art from the detailed description given hereinabove, it will be understood that the present invention is limited only as provided in the claims appended hereto.

1. A utility knife comprising a handle and a blade holder, said blade holder being pivotally mounted on said handle for movement from an unfolded position to a folded position, said blade holder comprising a substantially flat elongated main wall and a substantially flat elongated guard wall mounted together in parallel relationship to each other, said walls having a space therebetween to receive a blade therebetween, said space being substantially parallel to said walls, locking means to hold said blade between said walls, said locking means being pivotally mounted on a wall of said blade holder, said locking means comprises lever means movable relative to the wall to hold a blade on the blade holder between said walls, said lever means having a body having a thing edge and a depending body said depending body being substantially parallel to the walls and being moveable in a direction to parallel said walls said lever means having activating means extending therefrom to a position outside said walls and operable from outside said walls to move said lever means.

2. A utility knife as set forth in claim 1 wherein said guard wall and said main wall are mounted together and have a slit therebetween adapted to receive a blade.

3. A utility knife as set forth in claim 2 wherein said locking means comprise a blade lock arm mounted for pivotal movement relative to said main and guard walls from an open position to a closed position.

4. A utility knife as set forth in claim 3 wherein said blade lock arm comprises a blade finger extending therefrom and adapted to enter a notch in a blade to hold the blade in place when the blade lock arm is in said closed position.

5. A utility knife as set forth in claim 4 wherein said lock blade arm is adapted to enter a groove in said blade holder when in said closed position.

6. A utility knife as set forth in claim 5 wherein said groove comprises opposed thinner upper edges of said walls.

7. A utility knife as set forth in claim 6 wherein said blade holder comprises a rear end and a front end, said front end comprising said guard wall and said main wall, said rear end being pivotally mounted to said handle and having upper and bottom edges.

8. A utility knife as set forth in claim 7 wherein said lock blade arm is pivotally mounted on said front end of said blade holder adjacent to said upper edge.

9. A utility knife as set forth in claim 8 wherein said groove has a clearance area therebeneath.

10. A utility knife as set forth in claim 8 wherein said blade lock arm has a finger tab extending therefrom.

11. A utility knife as set forth in claim 8 wherein a spring is provided to bias said blade lock arm to its closed position.

12. A utility knife as set forth in claim 8 wherein said handle comprises a pair of spaced handle halves adopted to form a space therebetween for receiving at least a portion of said blade holder when in its folded position and wherein said handle has a pivoted lock lever assembly mounted in the said space in the handle and wherein said lock lever assembly has a front arm and a rear arm and a lock finger extending from its front arm.

13. A utility knife as set forth in claim 12 wherein said rear end of the blade holder has a groove therein adapted to receive said lock finger when the blade holder is in its unfolded position.

14. A utility knife as set forth in claim 13 wherein spring means are mounted beneath the rear arm of the lock lever assembly to bias the rear arm upwardly and to bias the front arm downwardly to permit the lock finger to enter the groove, whereby depressing the rear arm against the tension of the spring means will cause the front arm to rise and the lock finger to move out of the groove permitting the blade holder to pivot relative to the handle from an unfolded position to a folded position into the space in the handle.

15. A utility knife as set forth in claim 14, wherein the handle has a notch in its top edge and wherein the rear arm protrudes above the notch whereby depression of the rear arm at the notch permits the front end to be raised upwardly and cause the lock finger to move out of the lock groove.

16. A utility knife as set forth in claim 7 wherein said lock blade arm is pivotally mounted on said rear end of said blade holder adjacent to said upper edge.

17. A utility knife as set forth in claim 16 wherein said blade lock arm comprises a two arm lever.

18. A utility knife as set forth in claim 17 wherein a spring is provided beneath one of said arms to bias said blade lock arm to its closed position.

19. A utility knife as set forth in claim 18 wherein said blade lock arm is comprised of a rear arm and a front arm and wherein said spring is provided beneath said rear arm to bias said front arm to its closed position within said groove.

20. A utility knife as set forth in claim 19 wherein said groove has a clearance area therebeneath.

21. A utility knife as set forth in claim 19 wherein said handle comprises a pair of spaced handle halves adopted to form a space therebetween for receiving at least a portion of said blade holder when in its folded position and wherein said handle has a pivoted lock lever assembly mounted in the said space in the handle and wherein said lock lever assembly has a front arm and a rear arm and a lock finger extending from its front arm.

22. A utility knife as set forth in claim 21 wherein said rear end of the blade holder has a groove therein adapted to receive said lock finger when the blade holder is in its unfolded position.

23. A utility knife as set forth in claim 22 wherein spring means are mounted beneath the rear arm of the lock lever assembly to bias the rear arm upwardly and to bias the front arm downwardly to permit the lock finger to enter the groove, whereby depressing the rear arm against the tension of the spring means will cause the front arm to rise and the lock finger to move out of the groove permitting the blade holder to pivot relative to the handle from an unfolded position to a folded position into the space in the handle.

24. A utility knife as set forth in claim 23, wherein the handle has a notch in its top edge and wherein the rear arm protrudes above the notch whereby depression of the rear arm at the notch permits the front end to be raised upwardly and cause the lock finger to move out of the lock groove.

25. A utility knife comprising a handle and a blade holder, said blade holder being pivotally mounted on said handle for movement from an unfolded position to a folded position, said blade holder comprising a substantially flat elongated main wall and a substantially flat elongated guard wall mounted together in parallel relationship to the other, said walls having means a space therebetween to receive a blade therebetween, said space being substantially parallel to said walls, locking means to hold said blade between said walls, said locking means being mounted on a wall of said blade holder for movement relative to said blade holder, said locking means comprises means moveable relative to the wall to hold a blade on the blade holder between said walls, said moveable means having a body having a thin top wall and a depending body substantially parallel the walls and being moveable in a direction parallel to said walls, said moveable means having activating means extending therefrom to a position outside said walls and operable from outside said walls to move said moveable means.

26. A utility knife as set forth in claim 25 wherein said guard wall and said main wall are mounted together and have a slit therebetween adapted to receive a blade.

27. A utility knife as set forth in claim 26 wherein said locking means comprise a blade lock arm mounted for movement relative to said blade holder.

28. A utility knife as set forth in claim 27 wherein said blade lock arm comprises an a blade finger extending therefrom and adapted to enter a notch in a blade to hold the blade in place when the blade lock arm is in said closed position.

29. A utility knife as set forth in claim 28 wherein spring means are provided to bias said blade lock arm toward said blade holder.

30. A utility knife as set forth in claim 29 wherein said blade holder comprises a rear end and a front end, said front end comprising said guard wall and said main wall, said rear end being pivotally mounted to said handle and having upper and bottom edges.

31. A utility knife comprising a handle and a blade holder, said blade holder being pivotally mounted on said handle for movement from an unfolded position to a folded position, blade holding means on said blade holder for removably holding a blade on said blade holder, said blade holding means comprising blade lock means moveably mounted on said blade holder, said blade holder comprising a rear end and a front end, and said rear end being pivotally mounted to said handle and having upper and bottom edges, means for locking and unlocking said blade holder in said unfolded position whereby unlocking said blade holder permits said movement of said blade holder to a folded position, said handle having a space for receiving at least a portion of said blade holder when the blade holder is in its folded position said means for locking and unlocking the blade holder comprising, said handle having a moveable lock assembly mounted in said space in the handle, a lock fingeron the moveable lock assembly, said rear end of the blade holder having a groove therein adapted to receive said lock finger when the blade holder is in its unfolded position.

32. A utility knife comprising a handle and, a blade holder, said blade holder being pivotally mounted on said handle for movement from an unfolded position to a folded position, blade holding means on said blade holder for removably holding a blade on said blade holder, said blade holding means comprising blade lock means moveably mounted on said blade holder, said blade holder comprising a rear end and a front end, said rear end being pivotally mounted to said handle and having upper and bottom edges, means for locking and unlocking said blade holder in said unfolded position whereby unlocking said blade holder permits said movement of said blade holder to a folded position said handle having a space for receiving at least a portion of said blade holder when the blade holder is in its folded position, said means for locking and unlocking the blade holder comprising, said handle having a moveable lock assembly mounted in said space in the handle, said lock lever assembly having a lock finger extending from the moveable lock assembly, said rear end of the blade holder having a groove therein adapted to receive said lock finger when the blade holder is in its unfolded position.

33. A utility knife as set forth in claim 26 wherein spring means are mounted beneath the rear arm of the lock lever assembly to bias the rear arm upwardly and to bias the front arm downwardly to permit the lock finger to enter the groove, whereby depressing the rear arm against the tension of the spring means will cause the front arm to rise and the lock finger to move out the groove permitting the blade holder to pivot relative to the handle from an unfolded position to a folded position into the space in the handle.

34. A utility knife as set forth in claim 27 wherein the handle has a notch in its top edge and wherein the rear arm protrudes above the notch whereby depression of the rear arm at the notch permits the front arm to be raised upwardly and cause the lock finger to move out of the groove.

35. A utility knife as set forth in claim 28 wherein said handle comprises a pair of spaced handle halves to form said space in the handle and wherein said lock lever assembly is mounted in said space.

36. A utility knife as set forth in claim 29 wherein said blade holder comprises a pair of walls and wherein said blade holding means is adapted to removably hold a blade between said walls.

37. A utility knife as set forth in claim 30 wherein said blade holding means comprises a blade lock assembly mounted on said blade holder.
